(19) United States
(12) Patent Application Publication
(10) Pub. No.: US 2009/0020003 A1
(43) Pub. Date: Jan. 22, 2009

(54) Anchor structure of rotation directing valve for pneumatic tool

(75) Inventor: Lung-Pao Chen, Hsinchu County (TW)

Correspondence Address: Joe McKinney Muncy, PO Box 1364, Fairfax, VA, 22038-1364, US

(73) Assignee: SUNMATCH INDUSTRIAL CO., LTD.

(21) Appl. No.: 11/826,760

(22) Filed: Jul. 18, 2007

(51) Int. Cl. F15B 15/26

(52) U.S. Cl. 91/444; 91/471

(57) ABSTRACT

An anchor structure of a rotation directing valve is used on a housing made from a composite material for pneumatic tools. A valve bushing in the housing is set under a cylinder. The rotation directing valve held by the valve bushing is to control a pneumatic motor in clockwise or counterclockwise rotation by moving it back and forth to alter the flow direction of compressed air. The anchor structure formed on the valve bushing anchors the rotation directing valve while the pneumatic motor rotates clockwise or counterclockwise.

### FIELD OF THE INVENTION

The present invention relates to an anchor structure of rotation directing valve and particularly to the anchor structure formed on a valve bushing to anchor a rotation directing valve set in the valve bushing.

### BACKGROUND OF THE INVENTION

A conventional pneumatic tool has an anchor structure as shown in FIG. 1. The pneumatic tool has a hosing 10 made of aluminum alloy, a rotation directing valve 16 to control a pneumatic motor (not shown in the drawing) in clockwise or counterclockwise rotation by altering the flow direction of compressed air, and a valve bushing 14 to hold the rotation directing valve 16. The housing 10 has a delimiting hole A to form an anchor structure B on the housing 10 which includes an anchor element 20 to make the valve 16 firmly set in the valve bushing 14, a spring 22 and a fastening screw 24. The valve bushing 14 is inserted in the housing 10. The rotation directing valve 16 has a plurality of grooves 160 corresponding to the anchor element 20. Furthermore, the anchor element 20 and the grooves 160 are buckled by each other to anchor the rotation directing valve 16 to be firmly set in the valve bushing 14.

As the anchor structure B has to be set in the drilled delimiting hole A on the housing 10, the housing 10 has to be made of rigid material such as the aluminum alloy in order to form the delimiting hole A through drilling. As a result, in the aspect of design, the housing 10 has to be made of rigid material in order to drill the delimiting hole A on it. Therefore, the anchor structure B can be set in the delimiting hole A. However, the housing made from rigid material is relatively heavier and can become a burden for the operators. Instead of the rigid material, making the housing 10 by light weight material such as the composite material can greatly reduce the burden to operators. However, the said anchor structure B to be used on the housing 10 made from the light weight material such as composite material is still not available yet on the market. Hence this issue is remained to be resolved in the industry.

### SUMMARY OF THE INVENTION

The primary object of the present invention is to provide an anchor structure of rotation directing valve to be used on a pneumatic tool's housing made from a composite material. A valve bushing in the housing is set under the cylinder. A rotation directing valve held by the valve bushing is to control a pneumatic motor in clockwise or counterclockwise rotation by moving it back and forth to alter the flow direction of compressed air. The anchor structure is directly formed on the valve bushing to firmly hold the rotation directing valve.

To achieve the foregoing object the invention of the anchor structure is to be used on the pneumatic tool's housing made from a composite material. A valve bushing in the housing is set under the cylinder. A rotation directing valve held by the valve bushing is to control a pneumatic motor in clockwise or counterclockwise rotation by moving it back and forth to alter the flow direction of compressed air. In this invention, it is characterized that the anchor structure which is formed on the valve bushing anchors the rotation directing valve while the pneumatic motor rotates clockwise or counterclockwise.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of a conventional pneumatic tool.

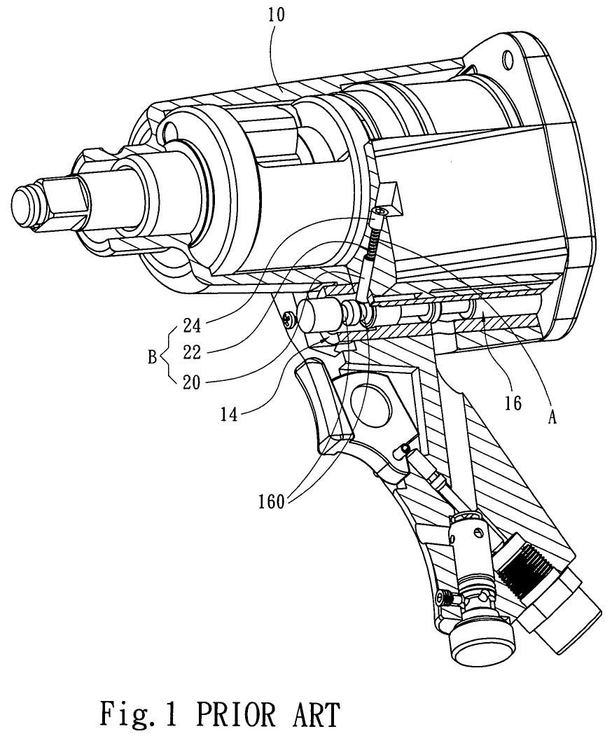

FIG. 2A is a perspective view of an embodiment of a pneumatic tool of the invention.

FIG. 2B a sectional view of an embodiment of a pneumatic tool of the invention.

FIG. 3A is a schematic view of an embodiment of the invention showing an assembly condition of an anchor structure, a valve bushing and a rotation directing valve.

FIG. 3B is an exploded view of an embodiment of the invention showing an anchor structure, a valve bushing and a rotation directing valve.

### DETAILED DESCRIPTION OF THE PREFERRED EMBODIMENT

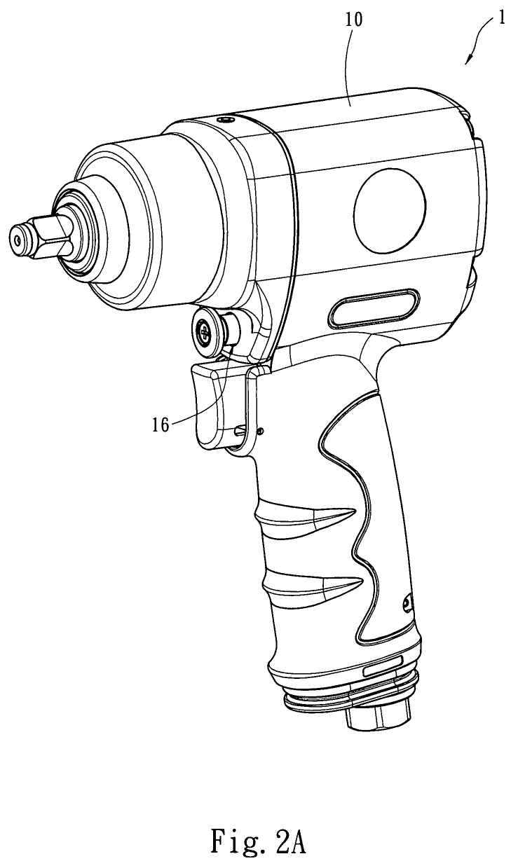

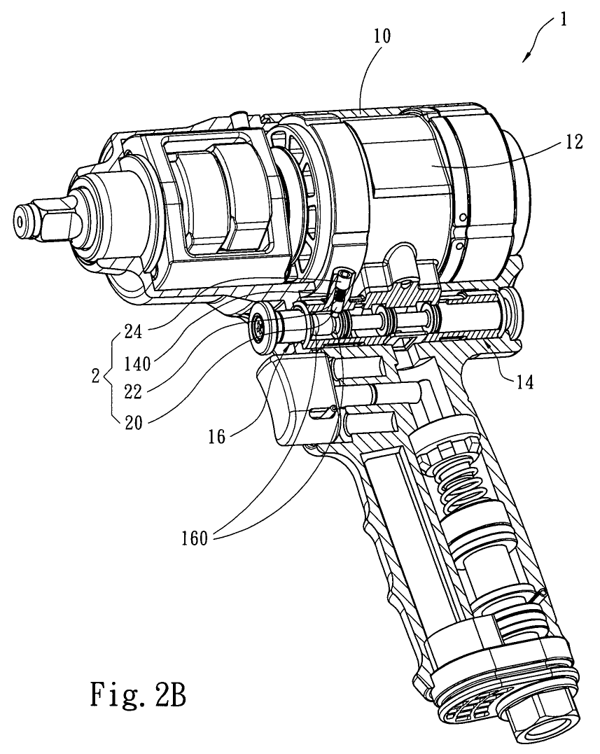

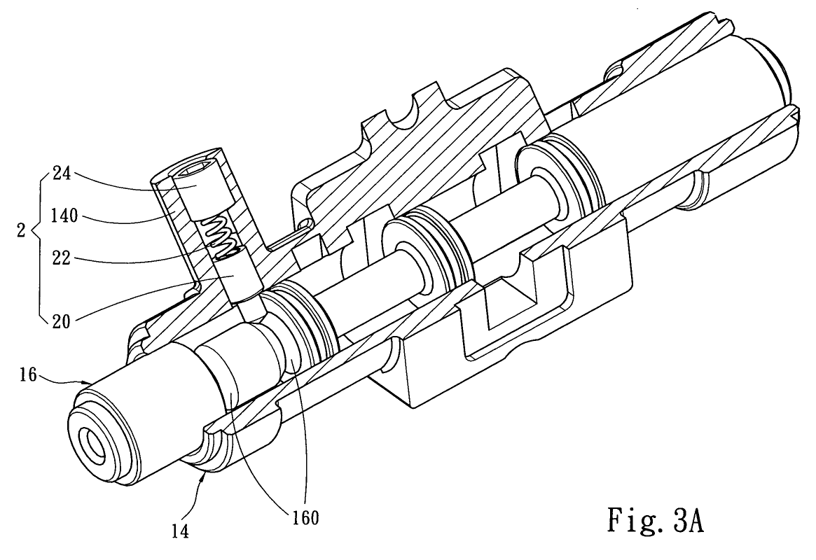

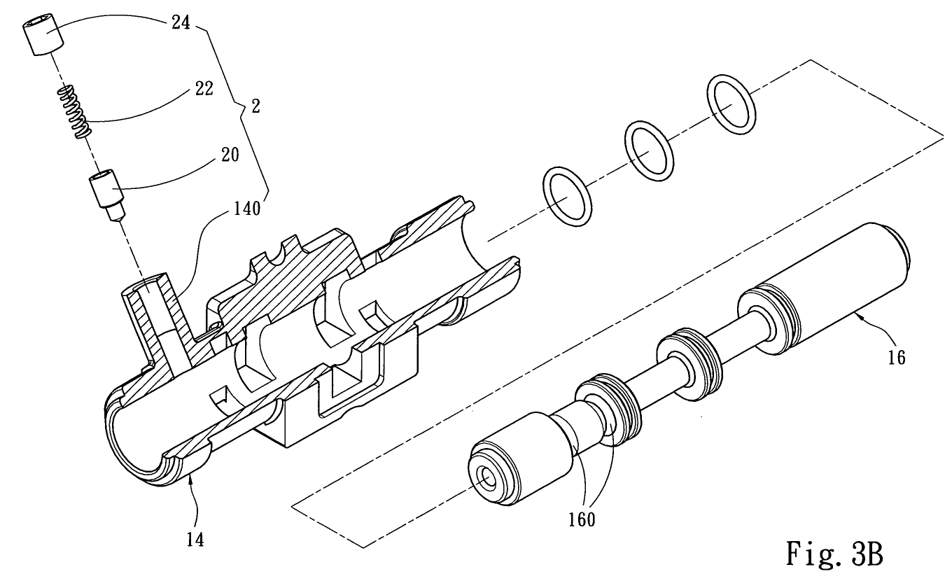

The present invention aims to provide an anchor structure of a rotation directing valve to be used on a housing made from a composite material of a pneumatic tool 1 (referring to FIGS. 2A and 2B). The pneumatic tool 1 includes a housing 10 made from a composite material. A valve bushing 14 in the housing 10 is set under a cylinder 12. A rotation directing valve 16 held by the valve bushing 14 is to control a pneumatic motor (not shown in the drawings) in clockwise or counterclockwise rotation by moving it back and forth to alter the flow direction of compressed air (also referring to FIGS. 3A and 3B). The invention is characterized that an anchor structure 2 formed on the valve bushing 14 firmly anchors the rotation directing valve 16 while the pneumatic motor rotates clockwise or counterclockwise.

According to an embodiment of the invention, the anchor structure 2 includes an anchor element 20, a holding duct 140, a spring 22 and a fastening screw 24. The rotation directing valve 16 has a plurality of grooves 160 corresponding to the anchor element 20 that are buckled by each other to anchor the rotation directing valve 16 to be firmly set in the valve bushing 14. Moreover, the holding duct 140 and the valve bushing 14 are formed in an integrated manner so that the valve bushing 14 and the anchor structure 2 also become an integrated body. In practice, the anchor structure 2 may also be fastened to the valve bushing 14 by screwing (through a screw and a screw hole). In addition, in the embodiment of the invention, the valve bushing 14 is fastened to the cylinder 12 through a fastening structure such as a screw and a screw hole (not shown in the drawings). In practice, the cylinder 12 and the valve bushing 14 may be formed in an integrated manner.

In short, the anchor structure 2 of the invention is directly formed on the valve bushing 14 in an integrated manner or fastened to the valve bushing 14 by screwing. Thus the limitation from the conventional pneumatic tool as its housing 10 has to be made from a rigid material such as aluminum alloy in order to provide a drilled delimiting hole for setting the anchor structure B can also be avoided. By forming the anchor structure 2 and the valve bushing 14 integrally or through screw fastening each other, the anchor structure 2 can be applied on a pneumatic tool's housing made from a composite material. Through this invention, the advantage of anchor structure 2 can be kept and the burden of tool's weight can be reduced to operators. It provides an important improvement over the conventional techniques.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An anchor structure of a rotation directing valve, to be used on a pneumatic tool's housing made from a composite material, comprising a valve bushing in the housing set under a cylinder and a rotation directing valve held by the valve bushing to control the pneumatic motor in clockwise or counterclockwise rotation by moving it back and forth to alter the flow direction of compressed air,
wherein an anchor structure formed on the valve bushing firmly anchors the rotation directing valve while the pneumatic motor rotates clockwise or counterclockwise.

2. The anchor structure of claim 1, wherein the cylinder and the valve bushing are formed integrally.

3. The anchor structure of claim 1, wherein the cylinder and the valve bushing are fastened together by screwing.

4. The anchor structure of claim 1, wherein the valve bushing and the anchor structure are formed integrally.

5. The anchor structure of claim 1, wherein the valve bushing and the anchor structure are fastened together by screwing.

6. The anchor structure of claim 1, wherein the anchor structure includes an anchor element, a spring, a fastening screw and a holding duct, moreover, the rotation directing valve has a plurality of grooves corresponding to the anchor element.
